(19) United States
(12) Patent Application Publication
(10) Pub. No.: US 2005/0246263 A1
(43) Pub. Date: Nov. 3, 2005

(54) Automated system for routing orders for foreign exchange transactions

(75) Inventors: David Ogg, Warren, NJ (US); William Lamartin, Bayport, NY (US); Mark Smith, Saint Petersburg, FL (US)

Correspondence Address: DAVIDSON, DAVIDSON & KAPPEL, LLC, 485 SEVENTH AVENUE, 14TH FLOOR, NEW YORK, NY, 10018, US

(73) Assignee: Lava Trading, Inc., New York, NY (US)

(21) Appl. No.: 10/834,812

(22) Filed: Apr. 29, 2004

(51) Int. Cl. G06F 17/60

(52) U.S. Cl. 705/37

(57) ABSTRACT

According to one exemplary embodiment of the present invention, a computerized method for routing orders for foreign exchange transactions is provided. The computerized method for routing orders includes a process for receiving and aggregating updated foreign exchange price information from a plurality of foreign exchange electronic markets, and receiving and aggregating updated foreign exchange price information from a plurality of multi-bank foreign exchange portals. Pursuant to a feature of the present invention, the received and aggregated foreign exchange information is merged and sorted according to preselected criteria, to create a complete order book.

### BACKGROUND OF THE INVENTION

There has long been a need for established markets for the buying and selling of the currencies of foreign countries, referred to as foreign exchange. For example, a business in the United States having cash deposits denominated in dollars, and desiring to purchase a commodity in France, would have to acquire Euros in order to complete the purchase transaction. Or, the French merchant selling the commodity, could decide to accept payment for the commodity in dollars, but would want to use the dollars to purchase Euros for deposit in its account in a French bank.

Historically, banks have been major market makers for foreign exchange. They are the principal source of liquidity for foreign exchange transactions. A customer, such as the treasurer of a multinational corporation, wanting to engage in a foreign exchange transaction to obtain, for example, Japanese yen, would call his or her bank to place a Request For Quote (RFQ). The customer would have a credit rating at the bank, and depending upon such factors as the customer's credit rating, the volume of the transaction, how good a customer the treasurer is to the bank, and so on, the bank would provide a quote to the customer. In this case, for example, the quote would be a yen per dollar figure.

The bank would typically be a member of one or more established, bank-member-only foreign exchange markets. These foreign exchange markets are referred to as sell-side foreign exchange markets because the trading members are typically solely banks and other providers of liquidity to the market. Examples of such sell-side foreign exchange markets are EBS and the foreign exchange market maintained for banks and other liquidity providers by Reuters.

The bank would base its customer quote on the current pricing for the desired currency in the sell-side foreign exchange market, and may include a mark-up on the current price to insure a profit for the bank. A sophisticated customer may call several banks to place RFQ's, and thereby obtain the best and fairest price available for his or her foreign exchange transaction. However, the placing of several phone calls, assembly of the quote information from the several banks, and the placing of additional phone calls to finalize the foreign exchange order, is an inefficient and cumbersome process. In addition, in order to be able to complete transactions, the customer would have to have credit established with each of the several banks he or she typically called for foreign exchange information.

In recent years, the convenient availability of more and more advanced and sophisticated computer capabilities, including high speed communications, has enabled banks and other entities to streamline the process. For example, many banks now offer an Internet site for foreign exchange transactions. Thus, a customer, rather than place a call to his or her bank, can simply go on line to get quotes and place orders. However, in order to be assured of a best and fair price, the customer would have to visit the sites of several different banks.

At the present time, there are efforts to further computerize and streamline the foreign exchange market. These efforts include the establishment of electronic foreign exchange trading platforms. A trading platform is a computer network that couples various parties, such as traders and brokers, as well as entities that provide liquidity, such as banks, to one another to facilitate and provide for the distribution of foreign exchange information, and/or the execution of foreign exchange transactions. These networks offer a full and efficient utilization of the high speed data communications provided by present day, commercially available computer equipment and networking infrastructures.

Examples of current foreign exchange trading platforms are multi-bank foreign exchange portals now available on the Internet. A number of large multi-national banks, such as JPMorgan Chase, Deutsche Bank and Citibank, each provide foreign exchange quotes to a portal. Subscribers to the portal can therefore receive and view, at one location, a set of quotes from some of the largest providers of liquidity in the foreign exchange market.

Another innovation in the foreign exchange market is the use of a “prime brokerage” account. Rather than set up a credit rating at each of several banks, a customer can establish a credit rating at one bank that then acts as a prime broker in all transactions for that customer. This, in effect, places the prime broker bank as a representative for the credit of the particular customer, to the rest of the world.

There are also efforts to establish foreign exchange trading platforms as electronic foreign exchange markets whereby members of the market can directly submit orders, either bids for the purchase of a foreign currency or asking prices for the sale of the currency. A matching engine in the electronic exchange would then match bid and asking prices to complete transactions. Such a scheme can eliminate the bank as a middle man, and reduce transaction costs.

While these innovations improve transaction processing, and streamline the procedures for obtaining multiple quotes, many foreign exchange trading platforms add further, separate layers of liquidity to the foreign exchange market. In addition to the ability to place a series of phone calls to several banks, there now also exists many alternative foreign exchange trading platforms, such as multi-bank portals and electronic exchanges. A customer will have to become a member of or subscribe to several different foreign exchange trading platforms, to be assured of having the best information on the fairest prices currently available for the currency of interest to the customer.

There is also an added complexity caused by the simultaneous existence of information regarding actual orders for foreign exchange on the various foreign exchange trading platforms such as the electronic exchanges, and bank quotes on the multi-bank portals. A customer who subscribes to several portals and is a member of several exchanges may need several screens in front of him or her to be able to view and take advantage of all of the information simultaneously.

### SUMMARY OF THE INVENTION

In accordance with a first embodiment of the present invention, a computerized method for routing orders for foreign exchange transactions is provided. The computerized method for routing orders includes a process for receiving and aggregating updated foreign exchange price information from a plurality of foreign exchange electronic markets, and receiving and aggregating updated foreign exchange price information from a plurality of multi-bank foreign exchange portals. Pursuant to a feature of the present invention, the received and aggregated foreign exchange information is merged and sorted according to preselected criteria, to create a complete order book.

In accordance with a second embodiment of the present invention, a computerized method for routing orders for foreign exchange transactions is provided. The computerized method for routing orders includes a process for receiving and aggregating updated foreign exchange price information from a plurality of foreign exchange trading platforms and receiving a foreign exchange order from a party. Pursuant to a feature of the present invention, the order is matched with the aggregated, updated foreign exchange price information to determine a pair of opposing orders for execution from among the plurality of foreign exchange trading platforms. In the event there is a match, the determined pair of opposing orders is executed. In the event there is not a match, an RFQ representing the foreign exchange order is generated, and the RFQ is transmitted to the plurality of foreign exchange trading platforms.

In accordance with a third embodiment of the present invention, a computerized method for routing orders for foreign exchange transactions is provided. The computerized method for routing orders includes a process for receiving and aggregating updated foreign exchange price information from a plurality of foreign exchange trading platforms. Upon the aggregation of price information, the process further involves receiving a foreign exchange order from a party, and matching the order with the aggregated, updated foreign exchange price information to determine a pair of opposing orders for execution. Pursuant to a feature of the present invention, an automatic routine for a pre-execution check to the determined pair of opposing orders is performed, and execution of the determined pair of opposing orders proceeds only if the pre-execution check succeeds.

In accordance with a fourth embodiment of the present invention, a computerized method for routing orders for foreign exchange transactions is provided. The computerized method for routing orders includes a process for receiving and aggregating updated foreign exchange price information from a plurality of foreign exchange trading platforms. Upon the aggregation of price information, the process further involves coding the aggregated foreign exchange information to highlight best trade information from among the foreign exchange trading platforms, and transmitting the coded, aggregated foreign exchange information to a user.

In accordance with a fifth embodiment of the present invention, a computerized method for routing orders for foreign exchange transactions is provided. The computerized method includes the utilization of an interface to couple a user to a plurality of foreign exchange trading platforms, with each of the foreign exchange trading platforms having, in turn, a coupling to a plurality of RFQ service providers. The RFQ service providers will each be one of a plurality of distinct types of RFQ service providers. The method according to the present invention proceeds to receive at the interface, an RFQ from the user, the RFQ specifying types of RFQ service providers. The interface is operated to distribute the RFQ to the types of RFQ service providers specified in the RFQ. After distribution, the interface receives responses to the RFQ from the plurality of specified RFQ service providers, and transmits the responses to the user.

In accordance with a sixth embodiment of the present invention, a computerized method for routing orders for foreign exchange transactions is provided. The computerized method includes the utilization of an interface to couple a user to a plurality of foreign exchange trading platforms, with each of the foreign exchange trading platforms having a coupling to a plurality of RFQ service providers. The method according to the present invention proceeds to receive at the interface, an RFQ from the user. The interface is operated to distribute the RFQ to the RFQ service providers. After distribution, the interface receives responses to the RFQ from the plurality of RFQ service providers, and transmits the responses to the user. The interface further receives a single response selected from among the responses by the user for execution as an order, and performs an automatic routine for a pre-execution check to the response selected by the user for execution as an order. The order is executed only if the pre-execution check succeeds.

In accordance with a seventh embodiment of the present invention, a computerized method for routing orders for foreign exchange transactions is provided. The computerized method includes the utilization of an interface to couple a user to a plurality of foreign exchange trading platforms, each of the foreign exchange trading platforms having a coupling to a plurality of RFQ service providers operating according to a preselected protocol. The method according to the present invention proceeds to receive at the interface, an RFQ from the user. The interface is operated to translate and distribute the RFQ to the RFQ service providers, each according to the corresponding protocol. After distribution, the interface receives at the interface, responses to the RFQ from the plurality of RFQ service providers. The interface thereafter translates and transmits the responses to the user.

In accordance with further embodiments of the present invention, computer systems are provided, which include one or more computers configured (e.g., programmed) to perform the methods described above. In accordance with other embodiments of the present invention, computer readable media are provided which have stored thereon computer executable process steps operable to control a computer(s) to implement the embodiments described above.

### BRIEF DESCRIPTION OF THE DRAWINGS

FIG. 1 is a block diagram of an exemplary system that can be used to implement embodiments of the present invention.

FIG. 2 shows an illustrative flow chart for implementing foreign exchange order book aggregation, according to a feature of the present invention.

FIG. 3 is a diagram showing sample bank foreign exchanges quotes.

FIG. 4 is a diagram showing sample bid and offer orders.

FIG. 5 is a diagram showing a sample of Complete Order Book, prepared in accordance with a feature of the present invention.

FIG. 5A is a diagram showing a sample of a version of the Complete Order Book of FIG. 5, for distribution to users, prepared in accordance with a feature of the present invention.

FIG. 6 shows an illustrative flow chart for implementing a foreign exchange order book matching process, according to a feature of the present invention.

FIG. 7 shows an illustrative flow chart for implementing a management routine for Requests For Quotes in a foreign exchange market, according to a feature of the present invention.

FIG. 8 is a schematic diagram of a sequence of events for a transaction involving a spot price derived from a futures price, according to a feature of the present invention.

### DETAILED DESCRIPTION OF THE PREFERRED EMBODIMENTS

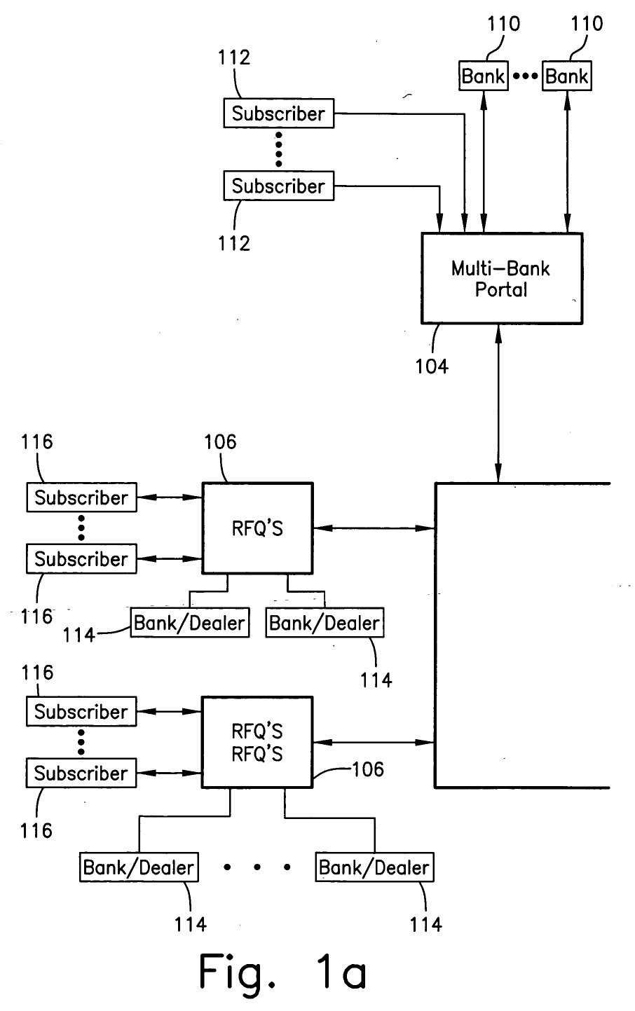

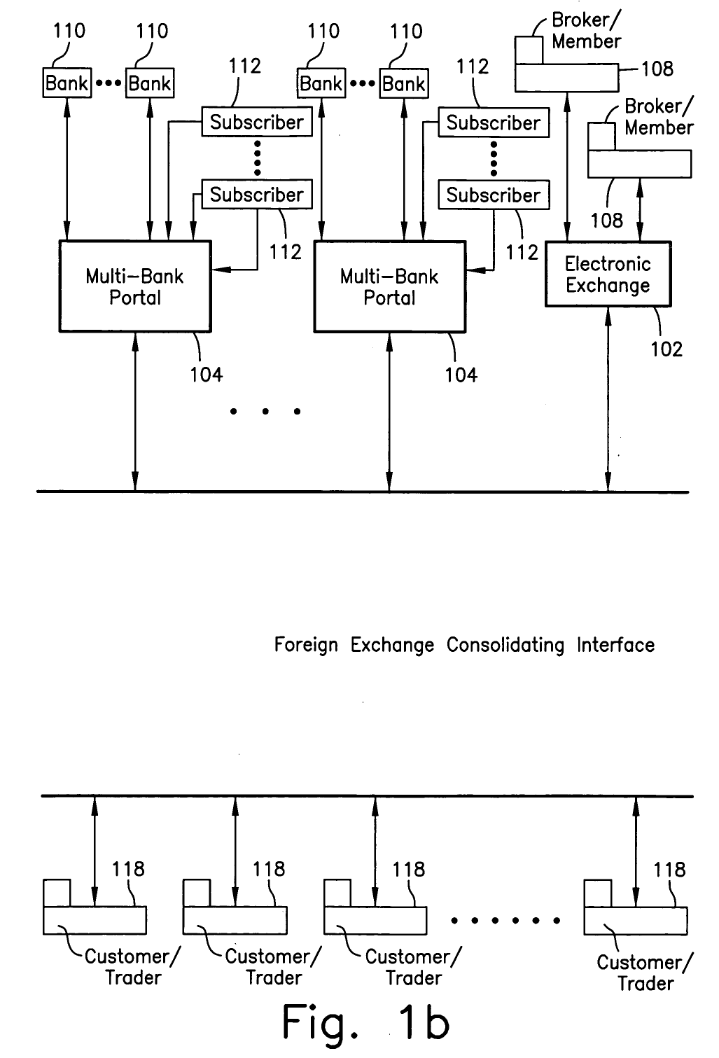

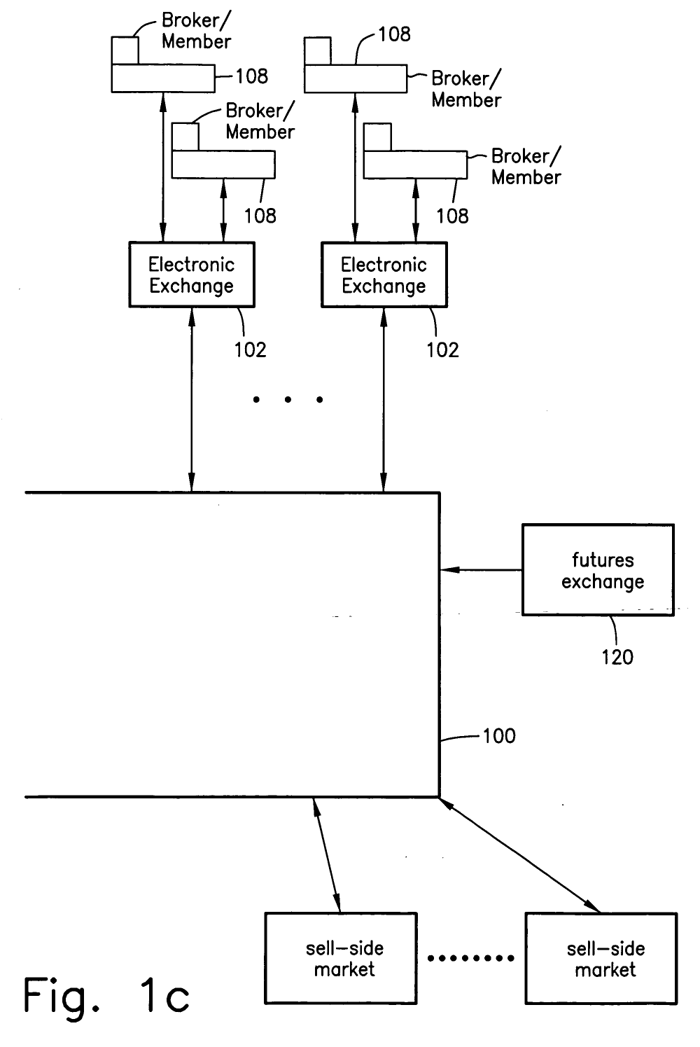

Referring now to the drawings, and initially to FIG. 1, there is illustrated a block diagram of an automated system for routing orders and information relating to foreign exchange transactions. In accordance with an exemplary embodiment of the present invention, a foreign exchange consolidating interface 100 is arranged to be coupled to each of a series of foreign exchange trading platforms such as, for example, foreign exchange electronic exchanges 102, multi-bank portals 104, and foreign exchange Request For Quote information services 106. The foreign exchange consolidating interface 100 can comprise a computer.

Each of the electronic exchanges 102 is, in turn, coupled to members 108, who may be brokers or traders. Each member 108 is granted trading privileges by the respective electronic exchange. Moreover, each member 108 is provided with, for example, a desk top computer electronically coupled to the respective electronic exchange 102, and which is arranged to transmit and receive foreign exchange order information to and from the respective electronic exchange 102. The order information transmitted by members 108 may comprise, for example, a bid price and quantity for the purchase of a particular desired foreign currency (a buy order), or an asking price and quantity for the sale of the currency (a sell order).

In this exemplary embodiment of the present invention, the electronic exchange 102 comprises a server computer operated to create an order book from the information gathered from its various members 108. The order book includes a list of open orders (including order information such as side (buy or sell), bid and asking prices, and quantities) gleaned from the orders transmitted by the members 108. The list of open orders includes orders at and away from the market price. Each member 108 receives a continuously updated copy of the order book from the electronic exchange 102 for display on the desk top computer so that each member 108 can be made aware of the current market for each currency. The electronic exchange 102 also comprises an order matching engine operated to match buy and sell orders in the order book that overlap in terms of both price and quantity. Each match made by the order matching engine becomes an executed order to complete a foreign exchange.

Each of the multi-bank portals 104 is coupled to a number of banks 110. Each of the banks 110 coupled to a particular multi-bank portal 104 is a market maker in foreign exchange and has agreed to provide a price feed to the respective portal 104. The price feed comprises both bid and asking prices for each currency traded by the bank 110. This is because, as a market maker, the bank is prepared to both buy and sell each currency traded by the bank 110. In this manner, the bank is a provider of liquidity for the marketplace.

A number of subscribers 112 are also coupled to each of the multi-bank portals 104. Each subscriber 112 is, for example, a trader or broker interested in completing foreign exchange transactions using one of the banks 110 providing a feed to the respective multi-bank portal 104. The subscribers 112 can be coupled to the respective portal 104 via the Internet. The price feeds from the various banks 110 are combined by the portal 104 for electronic distribution to the subscribers 112 of the respective multi-bank portal 104. In this manner, each subscriber 112 receives foreign exchange information from several banks 110 simultaneously. In some instances, a single bank 110 can maintain a portal for a number of subscribers 112.

In addition to the electronic exchanges 102 and multi-bank portals 104, a number of “Request for Quote” (RFQ) services 106 are also coupled to the foreign exchange consolidating interface 100. As discussed above, many foreign exchange traders, prior to placing an actual order, will request a quote from a bank or other RFQ service provider. This is particularly true when the proposed foreign exchange transaction is for a large amount of money. Recently, trading platforms in the form of RFQ services 106 have been established to collect RFQ information from a number of bank/broker/dealers 114, so that their subscribers 116 can make requests to multiple banks and/or other parties providing quotes, and view composite information on recent RFQ's. In this manner, the subscribers 116 can obtain a better understanding of the current market for a currency of interest to the subscriber 116.

Pursuant to a preferred embodiment of the present invention, the foreign exchange consolidating interface 100 operates to receive the foreign exchange information made available by each of the foreign exchange trading platforms, such as the electronic exchanges 102, multi-bank portals 104, and RFQ services 106, coupled to the interface 100. The foreign exchange consolidating interface 100 then aggregates the foreign exchange information received from each of the electronic exchanges 102, multi-bank portals 104 and RFQ services 106 coupled to the interface 100 to generate a Complete Order Book. The Complete Order Book includes for a given currency pair (for example, Euro/US dollar) a list of open orders derived from the foreign exchange information aggregated from the various foreign exchange trading platforms. Each order has corresponding indications of side, price and quantity.

Pursuant to another feature of the present invention, the consolidating interface 100 can also be coupled to existing foreign exchange futures markets such as the Chicago Mercantile Exchange 120 to obtain streaming quotes of futures trades in the foreign exchange futures markets.

The consolidating interface 100 can also be directly coupled to established sell-side markets 122, such as the EBS bank-member foreign exchange market, or the foreign exchange market maintained for banks and other liquidity providers by Reuters. In this manner, the sell-side markets can be utilized to provide an additional direct source of liquidity to the foreign exchange markets.

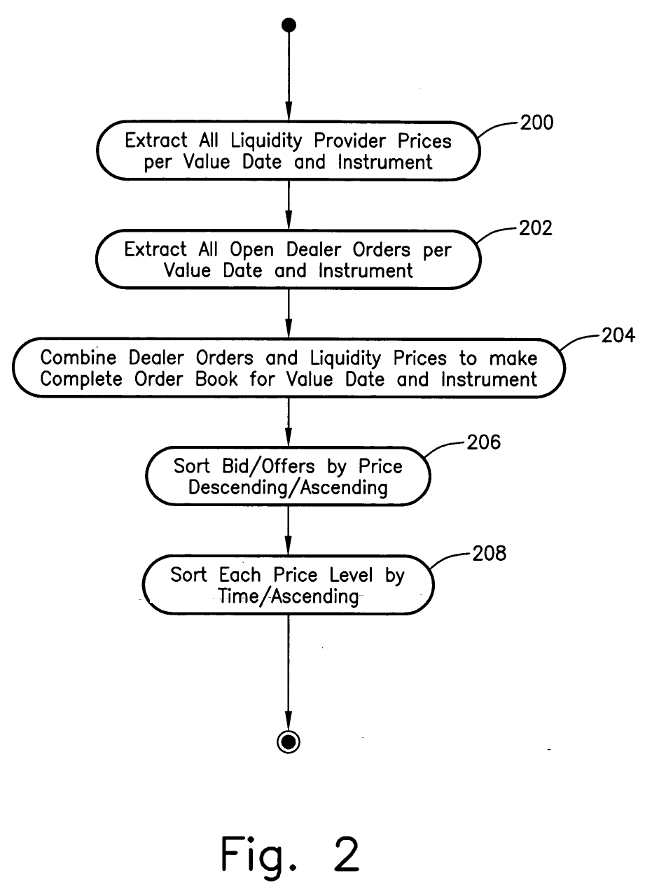

Referring now to FIG. 2, there is shown a flow chart of the aggregation process performed by the foreign exchange consolidating interface 100, of market data contained in the foreign exchange information received from the various foreign exchange trading platforms coupled to the interface 100. As noted above, the consolidating interface 100 operates to generate the Complete Order Book, according to a feature of the present invention. The foreign exchange consolidating interface 100 must merge market data obtained from all banks and other liquidity providers, together with trade data generated by the members of the various electronic exchanges to form an order book for each currency pair being traded, for example, all order and price information for currency pairs, such as, for example, Euro/US dollar exchanges, yen/US dollar exchanges, etc.

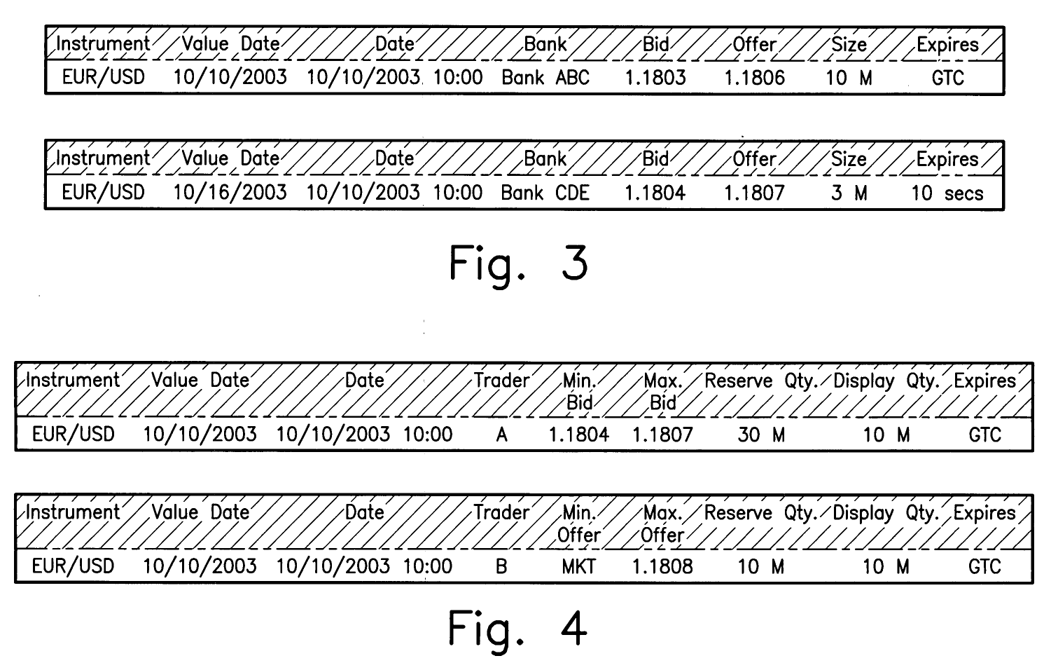

In step 200, the foreign exchange consolidating interface 100 collects all currently available prices from the liquidity providers, for example, all of the banks 110 transmitting price feeds to the various multi-bank portals 104 coupled to the consolidating interface 100, and price quotes from the various sell-side markets 122. Typically, each bank provides both a bid and ask price for each currency pair that it trades. FIG. 3 illustrates sample quotes that can be collected from the bank price feeds. Each quote specifies an instrument, such as a Euro/US Dollar foreign exchange (indicated as EUR/USD in the quote). The quote also specifies the value or settlement date, date of the quote, the bank making the quote, the bid and asking (or offer) prices, a size for the transaction, and an expiration for the quote. In our example, bank ABC and bank CDE provide quotes that offer EUR/USD foreign exchanges at varying bid and offer prices and sizes. The prices quoted by the ABC bank are good until the close of business, while the prices of the CDE bank are good for 10 seconds.

In step 202, the foreign exchange consolidating interface 100 then collects all open orders entered by members 108, per instrument and value date, from the various electronic exchanges 102. FIG. 4 illustrates sample orders placed in one of the electronic exchanges 102 by trader A and trader B, who are members 108 of the respective electronic exchanges 102, and collected by the foreign exchange consolidating interface 100. As in the case of a bank quote, each order specifies the instrument (EUR/USD currency pair), a value date, and an expiration. However, since each member 108 is either buying or selling a currency, each order specifies only one of a bid price, in the case of a buy order, or an offer price, in the case of a sell order.

As shown in the samples of FIG. 4, each open order has both a minimum price and a maximum price to support discretionary and other forms of limit orders. In other words, the trader (member 108), by specifying a price range, agrees to an order execution at any price within the range to facilitate completion of execution. The price in an order can be specified by a trader as “market price” (MKT). A market price indicates that a particular trader is willing to execute a buy or sell at the current market price for the currency. The information collected can also include a display quantity and a reserve quantity.

Pursuant to a feature of the present invention, an electronic exchange 102 can be arranged to receive an order from a trader that indicates both a given quantity that can be displayed on a market order book (the disclosed liquidity), and a hidden or reserve quantity (the undisclosed liquidity). When such an order is placed, other members of the electronic exchange will only be informed about the disclosed quantity. A member would use the undisclosed liquidity approach to minimize market impact of his or her order, especially when the quantity is large. The exchange can execute orders from the undisclosed liquidity to the extent it is able, from matching quantity and price comparisons from among other disclosed liquidity orders of other members.

In step 204, the foreign exchange consolidating interface 100 merges the information collected from the various foreign exchange trading platforms by grouping all of the collected, and yet to expire open orders and bank feed quotes. The groupings are made by type of instrument (e.g. all EUR/USD's from open orders and liquidity provider quotes), and value date.

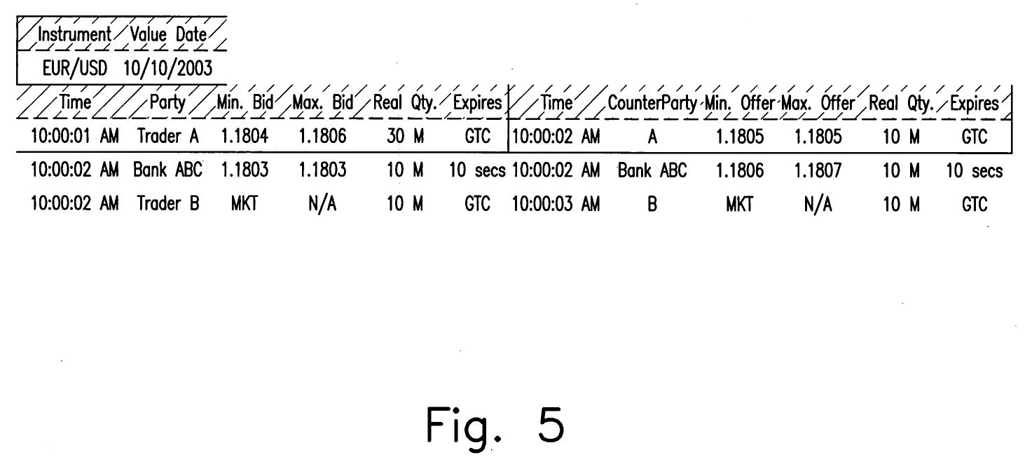

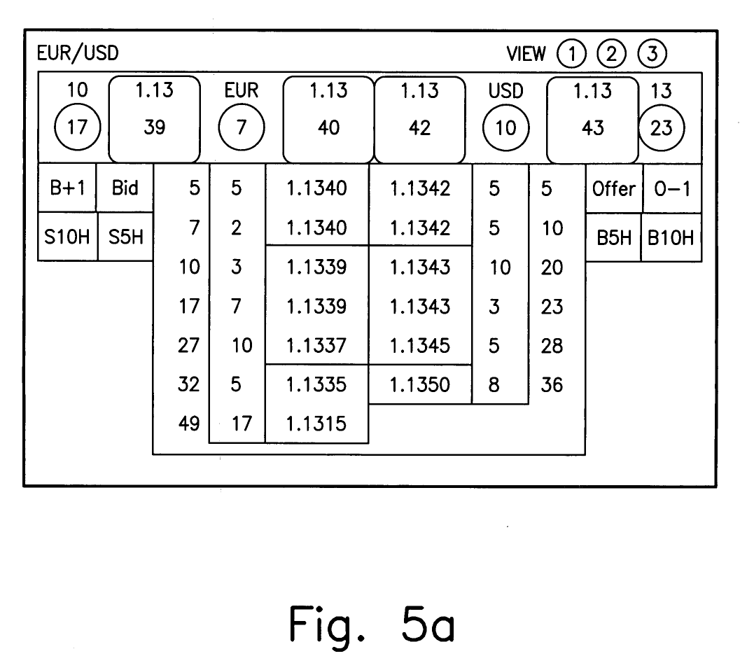

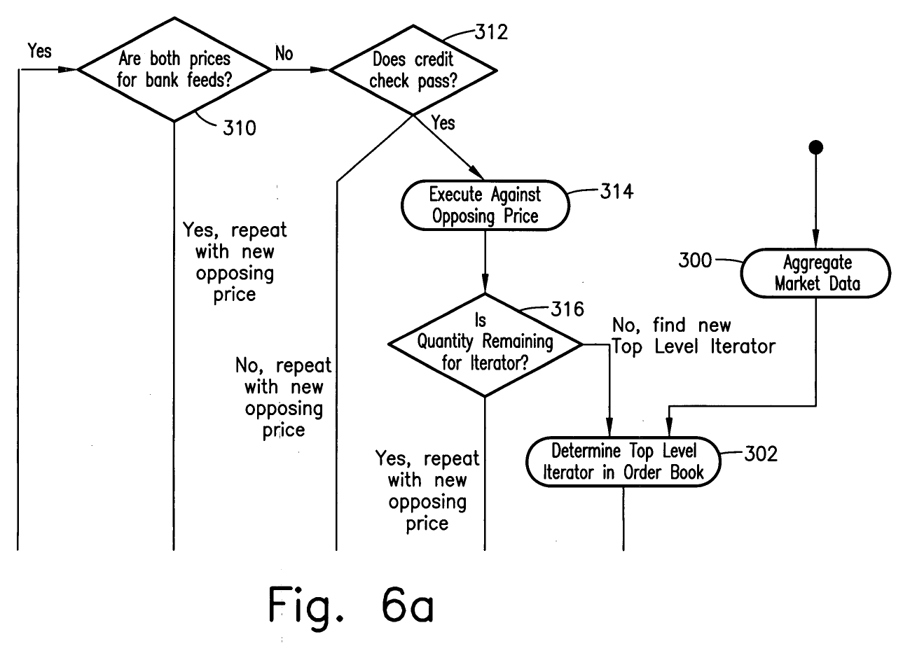

In steps 206, 208, the consolidating interface 100 applies price-time sorting to each of the groupings, to prepare the Complete Order Book. As shown in FIG. 5, the consolidating interface 100 sorts all collected bid and asking prices, each in a separate column or array. The two columns are arranged side-by-side, bids on the left and offers on the right, to provide bid/offer pairs. The consolidating interface 100 sorts all unexpired and available bids and offers in descending/ascending order, respectively, by price, and then sorts each price level in ascending order by the time the order was placed in the complete order book. For example, a price of 1.1806 received at 10:00 am would be placed in the order book before a price of 1.1806 received at 10:01 am.

Market orders are initially excluded from the price-time sorting process. The top level bid/offer price pair, for a particular instrument and value date, after the sorting, is designated as the Liquidity Quote for that instrument. At this time, all orders designating “market price” are valued based upon the current Liquidity Quote for the respective instrument and value date. Market Buy orders are assigned a bid price equal to the corresponding Liquidity Quote offer price, and Market Sell orders are assigned an offer price equal to the Liquidity Quote bid price.

Pursuant to an exemplary embodiment of the present invention, after the setting of bid/offer prices for Market Orders, steps 206,208 are repeated to resort all entries including Market Orders. At this point, the Complete Order Book is complete and up-to-date, and the aggregation process is ended. An aggregation of market data to update the Complete Order Book occurs with each change to information relating to the order book, such as, for example, each time a bank changes a quote in its price feed, a member of an electronic exchange submits a new order, or an existing order expires.

Pursuant to a feature of the present invention, a tag is maintained in the foreign exchange consolidating interface 100, for each entry in the Complete Order Book, to indicate the platform source of the price information. For example, the tag would identify either the electronic exchange 102 or multi-bank portal 104 from which the information in a quote or order entry was collected.

Referring once again to FIG. 1, a plurality of users, designated as brokers/traders/customers 118 in this exemplary embodiment, are each coupled to the foreign exchange consolidating interface 100. Each customer 118 has, for example, a desk top computer coupled to the interface 100 via the Internet. Each customer 118 will also be a member of one or more of the electronic exchanges 102, and/or subscribes to one or more of the multi-bank portals 104 and/or RFQ services 106. When a customer 118 has a prime brokerage relationship, the actual party participating in trades, and having membership or subscription status, can be the bank acting as the prime broker. Thus, the terms “user” or “customer,” as used herein, also refer to such prime brokerage relationships.

Rather than directly coupling to each of the foreign exchange trading platforms to which the customer 118 belongs or subscribes, the particular customer 118 interacts with these platforms via the foreign exchange consolidating interface 100. In this manner, the customer 118 can utilize foreign exchange information that is an aggregation of the information from foreign exchange trading platforms comprising the exchanges 102, multi-bank portals 104 and/or RFQ services 106 to which the customer 118 is entitled to receive trade information, as will now be described.

According to a feature of the present invention, the foreign exchange consolidating interface 100 maintains a table listing each broker/trader/customer 118, and indicating for each particular broker/trader/customer 118 all of the electronic exchanges 102 of which the broker/trader/customer 118 is a member, and all of the multi-bank portals and RFQ services to which he or she subscribes. This broker/trader/customer 118 information is used, along with the tag information associated with each entry in the Complete Order Book, as described above, by the consolidating interface 100 to filter the order information distributed to any particular broker/trader/customer 118. Thus, each broker/trader/customer 118 receives from the consolidating interface 100, a version of the Complete Order Book that contains only bid/offer information from foreign exchange trading platforms such as electronic exchanges 102 and/or multi-bank portals 104, to which he or she is entitled by virtue of membership or subscription (or a prime brokerage relationship). The consolidating interface 100 can distribute the various versions of the Complete Order book to the broker/trader/customers 118 in real time.

In a preferred embodiment of the present invention, the consolidating interface 100 can be operated to adjust prices listed in a version of the Complete Order Book distributed to a particular broker/trader/customer 118. The adjustment can be made to lower prices to provide preferential pricing to the selected broker/trader/customer 118, because of, for example, a good credit rating or good customer status. Or, the adjustment can be made to raise prices to add, for example, a bank fee related to the transaction. For instance, all broker/trader/customers 118 whose prime broker is a particular bank can have 0.0001 subtracted from each bid price, and 0.0001 added to each offer or asking price. This would result in a profit for the bank acting as the prime broker. Effectively, a fee has been charged on the transaction.

Referring now to FIG. 5A, there is illustrated a diagram showing a sample of a version of the Complete Order Book of FIG. 5, as arranged for distribution to broker/trader/customers 118, and prepared in accordance with a feature of the present invention. As noted above, the consolidating interface 100 only sends foreign exchange information that the particular broker/trader/customer 118 is entitled to receive, and strips all identification of parties and source from open order information, to maintain anonymity in the marketplace. The buy/sell pairs are arranged in columns, as in the Complete Order Book of FIG. 5, with a single quote per buy/sell pair. In this example, the buy prices range from “1.1340” to “1.1315,” and the sell prices range from “1.1342” to “1.1350.” The amount of each order is placed alongside the quoted price, the buy amount in a column to the left of the buy price, and the sell amount in a column to the right of the sell price. As can be seen in FIG. 5A, the best buy price has a volume “5,” which represents 5 million of the respective currency. Alongside the volume quantities is a column, in each of the buy and sell sides, to show a running total amount for all above quotes above. In this manner, a trader can be kept aware of the total size of the market available to him or her.

In addition, the information is coded, including color coding, to highlight certain information, such as, for example, a best trade among the list of open orders. As shown in FIG. 5A, the best trade information is arranged at the top of the display, with the two least significant figures of the price of each of the buy and sell sides of the trade enlarged and placed in light background fields. In this example, the figures “40” and “42” are shown. Above the enlarged figures appears the remaining, most significant figures of the respective quotes. In this case “1.13.” Also highlighted is the total amount available at each price.

Alongside the best trade figures are highlighted the least significant figures of the next best trade. In this case, “39” and “43.” Amounts for each of the buy and sell sides of the next best trade, and total amounts for the best and next best trades are also shown. Thus, a trader can easily view information on the size of the market, and the best trades available at the moment. In addition, function fields can be provided to expedite trading. The “Bid” and Offer” fields can be selectively clicked upon to initiate either a buy or sell transaction screen. “Fast Track” fields such as “B+1” and “O−1” allow the trader to expedite a trade by agreeing to trade at his or her bid or offer prices, plus or minus 1, respectively. The “S10H,” “S5H,” “B5H” and B10H” fields are for initiating an expedited trade for a fixed amount at the current market price. Thus, for example, “S10H” indicates a sell trade of 10 million at the market price.

The desk top computer of each broker/trader/customer 118 receives the corresponding version of the distributed Complete Order Book. The desk top computer includes a monitor to display the Complete Order Book. The broker/trader/customer 118 desk top computer can be programmed with sort and group features so that a customer 118 can arrange the aggregated price information contained within the version of the Complete Order Book received by the particular customer 118, according to the preferences of the particular customer 118.

The consolidating interface 100 can also send quote information obtained from the futures exchanges 120, to each of the customers 118, for a better understanding of the foreign exchange market.

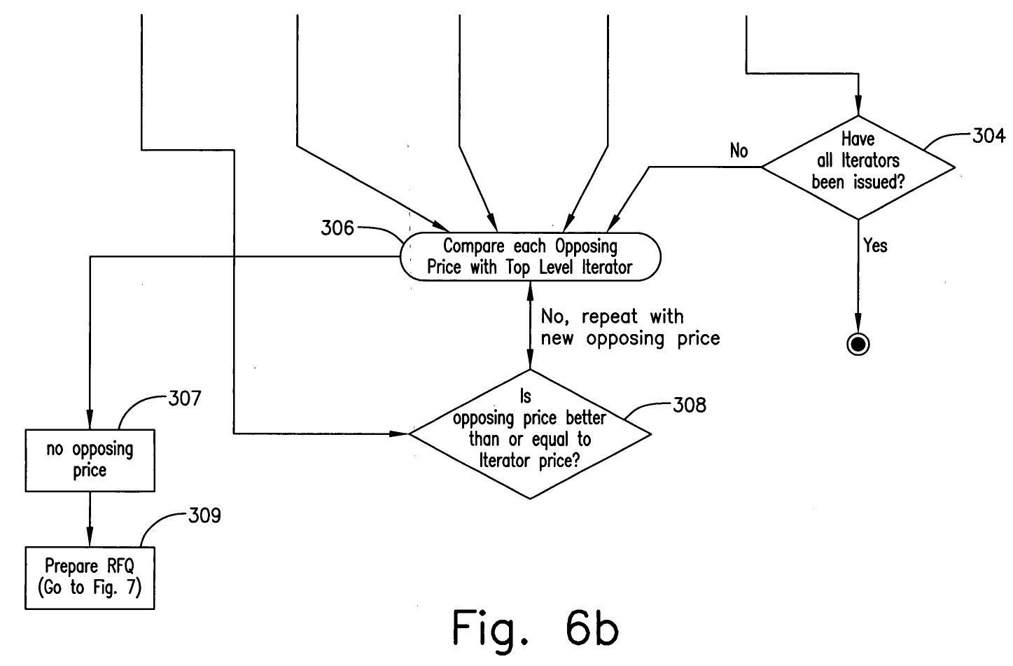

Referring now to FIG. 6, there is illustrated a flow chart for implementing a foreign exchange order book matching process, according to a feature of the present invention. Any new order submitted by a member 108 of an electronic exchange 102 or change in a bank price feed quote in any one of the multi-bank portals 104, will trigger the order matching process for a particular instrument, on a specific value date, for example EUR/USD for Oct. 10, 2003, as shown in FIG. 5. Initially, (step 300) an aggregation of market data to update the Complete Order Book for the particular instrument occurs, as described above. When the order is placed by a broker/trader/customer 118 coupled to the consolidating interface 100, the consolidating interface 100 acts as an intermediary for the broker/trader/customer 118 relative to all of the electronic exchanges 102 and multi-bank portals 104 coupled to the interface 100, and of which the particular broker/trader/customer 118 is a member or subscribes. The intermediary role is performed via an order matching function, and transmittal of a matched pair of orders to an appropriate electronic exchange 102 or multi-bank portal 104, as will now be described.

In step 302, the consolidating interface 100 extracts the Current Top Level bid/offer pairs from the Complete Order Book for the instrument. The Current Top Levels will be the best or maximum bid prices and opposing minimum offer prices available. From among these Current Top Levels, each of the earliest submitted bid and offer prices is selected. Then, between the bid and offer prices of the selected pair of the Current Top Levels, the earliest submitted price is selected as an aggressor for order execution, designated as the Top Level Iterator.

In the example of FIG. 5, the Current Top Levels for the EUR/USD instrument for the Oct. 10, 2003 value date are Bid of 1.1804 and Offer 1.1805. The Top Level Iterator for this instrument will be the Bid of 1.1804 since it was submitted earlier than the opposing offer.

In step 304, the consolidating interface 100 queries as to whether there is a Top Level Iterator to test for order execution. Since there is currently a Top Level Iterator to test (the Bid of 1.1804 for the EUR/USD instrument from our example), the interface 100 proceeds to step 306. While executing the order matching process for the current Top Level Iterator, additional orders may be placed, or other changes made to bank price feeds. If so, Complete Order Books for such other instruments and/or value dates will be updated, and new Top Level Iterators will have to be determined. In addition, a new Top Level Iterator for the current instrument and value date may be selected after the current Top Level Iterator is matched or order execution for the current Top Level Iterator is not be possible, due to, for example, unavailability of a suitable opposing price, or non-executable conditions. Thus, the process will pass through step 304 until all such Top Level Iterators have been tested. If there are no Top Level Iterators to be tested, the consolidating interface 100 exits the order matching process.

In step 306, the consolidating interface 100 compares the current Top Level Iterator to each opposite price. If the Top Level Iterator is a bid price, the comparisons are made to the opposite offer prices, and if the Top Level Iterator is an offer price, then the comparisons are made to the opposite bid prices. The comparisons are made until an opposing price is better than or equal to the price of the Top Level Iterator (step 308). In the case of a Top Level Iterator that is a bid price, the opposing ask price (or offer price) should be less than or equal to the bid price of the Top Level Iterator. In the case of a Top Level Iterator that is an offer price, then the opposing bid price should be greater than or equal to the offer price of the Top Level Iterator.

Upon the occurrence of a yes condition in step 308 (when there is an opposing price that is better than or equal to the Top Level Iterator price), the consolidating interface 100 proceeds to step 310. In the event of a no condition in step 308 (when the opposing price is not better than or equal to the Top Level Iterator price), the consolidating interface 100 returns to step 306 to select another opposing price.

In step 310, the interface 100 checks to determine the parties behind the matching prices, and any markings relevant to the two opposing orders or prices. The parties may be either one of the broker/trader/members 118, 108 who desire to submit an order or who have submitted an order to the various electronic exchanges 102 and/or one of the banks 110 providing price feeds to the multi-bank portals 104. The markings indicate when opposing orders are mutually non-executable, as will be describes in more detail below.

In the event that the two parties are banks 110, the trade is not executed. This is because banks typically utilize one of the bank-member only, sell-side exchanges such as EBS and Reuters, to trade foreign exchange, and there is no intention to execute a trade when an order match occurs as in this case. The banks 110 typically execute trades in the sell-side markets. If the two orders are marked as mutually non-executable, the trade is also not executed between the two parties. In either case, the consolidating interface 100 proceeds back to step 306 to compare the Top Level Iterator to a next opposing price. In this manner, trades that are not permitted or meant to occur are automatically blocked from trade execution.

In the event that the two parties are either two broker/trader/members 118, 108 or a bank 110 and a broker/trader/member 118, 108, the consolidating interface 100 proceeds to step 312 to begin a Check Cross-Party Credit for Trade routine and other pre-execution checks, pursuant to a feature of the present invention. The Check Cross-Party Credit for Trade routine automates the credit checking procedures required in foreign exchange transactions. The routine can include an automatic analysis of the parties' current positions and a calculation of exposure due to the proposed trade, for example, using a known exposure calculation method. The analysis can also include a calculation of margin available to the parties.

In the event that the credit check does not succeed, the orders are marked mutually non-executable, for future use in any subsequent order match, as described above, and the consolidating interface 100 returns to step 306, to compare the Top Level Iterator to a new opposing price.

In the event that the credit check succeeds, the consolidating interface 100 proceeds to step 314. However, prior to proceeding to step 314 (to execute the Top Level Iterator against the selected opposing price), the consolidating interface 100 performs an analysis regarding the quantities specified in the opposing orders/prices. If the Top Level Iterator is marked as an “All or None” order, that indicates that the party will only trade all of the specified quantity. If the party to the opposing order has not also designated the order as an All or None order, then the opposing quantity must be greater than or equal to the Top Level Iterator quantity to satisfy the quantity requirements of the Top Level Iterator. If both parties have specified All or None trades, then the quantities of both parties must be the same. If these quantity conditions are not meet, then a trade cannot occur between the two parties, and the consolidating interface 100 must proceed to step 306 to select a next opposing price.

Otherwise, an order match can be made as to a quantity amount that can be satisfied by both parties. For example if the Top Level Iterator is a bid for $15,000,000, and the selected opposing offer is for an amount of $10,000,000, the trade is executed for $10,000,000. Accordingly, there will be $5,000,000 remaining and still outstanding as the Top Level Iterator. In step 316, the consolidating interface 100 determines if any amount remains from the executed trade. If there is still an outstanding amount, the consolidating interface returns to step 306, to once again compare the Top Level Iterator to opposing prices. If there is no outstanding amount, the consolidating interface 100 returns to step 302, to determine a new Top Level Iterator, as described above.

Thus, the consolidating interface 100 operates to form an execution set of orders by matching an order associated with a current Top Level Iterator to several opposing orders, until the quantity requirement of the Top Level Iterator is satisfied. Each opposed order of the execution set will be transmitted to the foreign exchange trading platform where the order originated, as indicated by the attached tag. The consolidating interface 100 can consolidate confirmation information for all of the executions to provide a single confirmation to the party behind the Top Level Iterator, as if the order was satisfied by a single source.

Pursuant to a feature of the present invention, in connection with order matching and subsequent execution, the consolidating interface 100 can determine whether both of the parties to a matched order are customers 118 coupled to the consolidating interface 100. In the event that both parties are customers 118, the consolidating interface can operate to auto-execute the matched order. For example, each foreign exchange platform, as a condition to couple to the consolidating interface 100, can be made to agree to give the interface 100 authority to automatically complete execution upon a match between orders placed by two customers 118.

In the event that only one of the parties to the matched order pair is a customer 118, the consolidating interface 100 will transmit the order execution information to the appropriate electronic exchange 102 or multi-bank portal 104, as indicated in the tag attached to the order of the party that is not a customer 118. Since the party who is a customer 118 must be a member or subscriber to the electronic exchange 102 or multi-bank portal 104, either personally or by virtue of a prime brokerage relationship, in order to receive the trade information in the first place, the party who is a customer 118 will, by necessity, also be authorized to trade on the appropriate electronic exchange 102 or multi-bank portal 104.

Pursuant to another feature of the present invention, the consolidating interface 100 can be operated to derive a spot price from a futures contract by stripping the spot price from a future quote obtained from a futures exchange 120 coupled to the interface 100, and assigning the trading of the future price differential to another party willing to accept the futures risk, such as, for example, a financial intermediary that can be one of the banks 110. The stripped spot price can be aggregated with the other prices by the consolidating interface 100, and a customer 118 can execute orders against the stripped spot price in the same fashion as other prices in the Complete Order Book, as described above. A spot price is the current market price, and a future price (for delivery at a fixed date in the future) is slightly higher or lower than the spot price by an amount that reflects interest rates and the amount of time until the future date. Of course, the consolidating interface 100 can aggregate futures quotes received from several different futures exchanges 120, and use the aggregated futures price information in the stripping transaction.

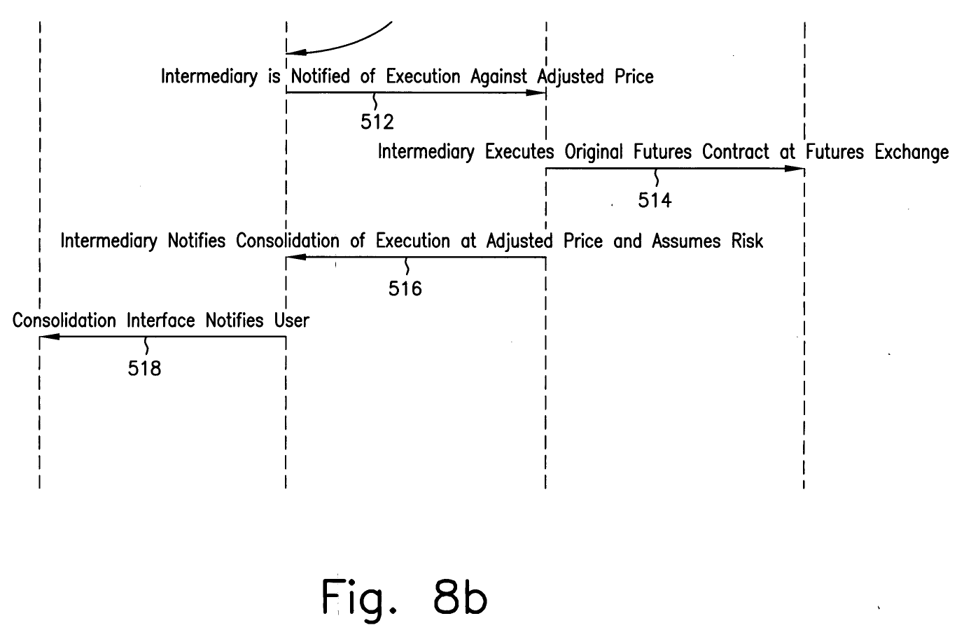

Referring now to FIG. 8, there is illustrated a schematic diagram of a sequence of events for a transaction involving a spot price derived from a futures price, according to a feature of the present invention. A bank 110 can receive a streaming quote of futures contract prices from a futures exchange 120 (event 500). The bank 110 adjusts the futures price by stripping the interest rate and time components of the futures price to derive a spot price, and transmits the adjusted price (spot price) to the consolidating interface 100 (502). (Events 500 and 502 can, in the alternative, be performed by the consolidating interface 100, which can be arranged to receive a streaming quote of futures contract prices from a futures exchange 120 directly, and perform the stripping adjustment on behalf of the bank 110). The consolidating interface 100 then aggregates the futures derived spot prices with other prices from the foreign exchange platforms, when generating the Complete Order Book (504), as described above. The value or settlement date for the futures contract has been converted to the spot price settlement date via this stripping process. The Complete Order Book is then distributed to the user/customers 118 (506) for display.

When a user/customer 118 desires to engage in a foreign exchange transaction for a spot date (current date), he or she will select a trade against a spot price as displayed in the respective version of the Complete Order Book, and then submit a corresponding order to the consolidating interface 100 (508). The spot price selected as a match for trade execution may in fact be the adjusted, stripped price of what was originally a futures contract, as described above. If this is the case, upon submission of the order, the consolidating interface 100 performs the foreign exchange order book matching process, as described above with respect to FIG. 6 (510). When an order match is determined, the bank 110 which adjusted the futures price in the first instance is notified regarding the match with the adjusted price (512).

At this point, the notified bank 110 executes the original futures contract upon which the price adjustment was made to derive the spot price, at the futures exchange 120, as is well known in the art (514). Upon confirmation of the execution, the bank 110 notifies the consolidating interface 100 of the execution (516). Thus, the bank 110 or other financial intermediary owns the futures contract, thereby assuming the risk associated with time and interest rate fluctuations, and will receive the spot price from the user/customer 118. The consolidating interface 100 then notifies the user/customer 118 of the execution (518). The customer 118 is thereby able to engage in foreign exchange spot transactions against futures prices, with forward risk stripped out and passed to a financial intermediary.

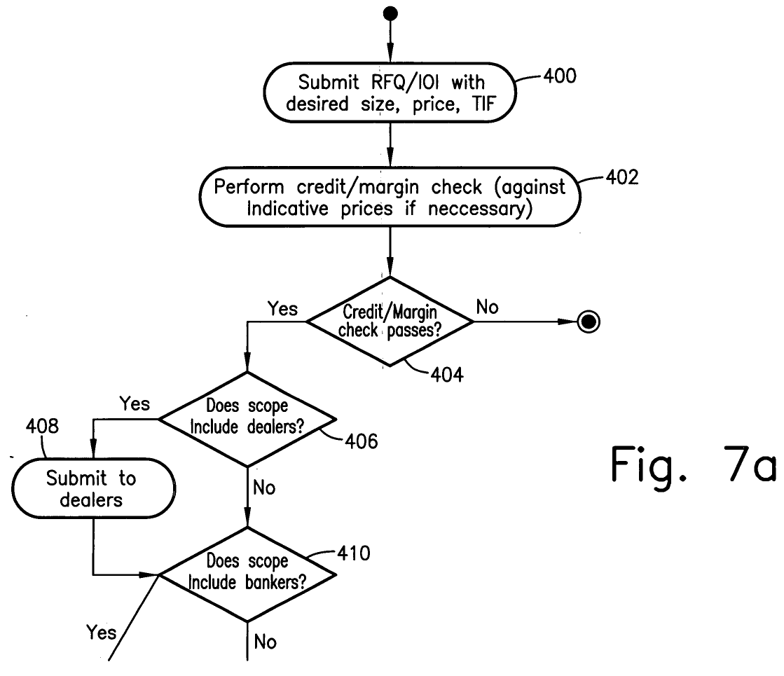

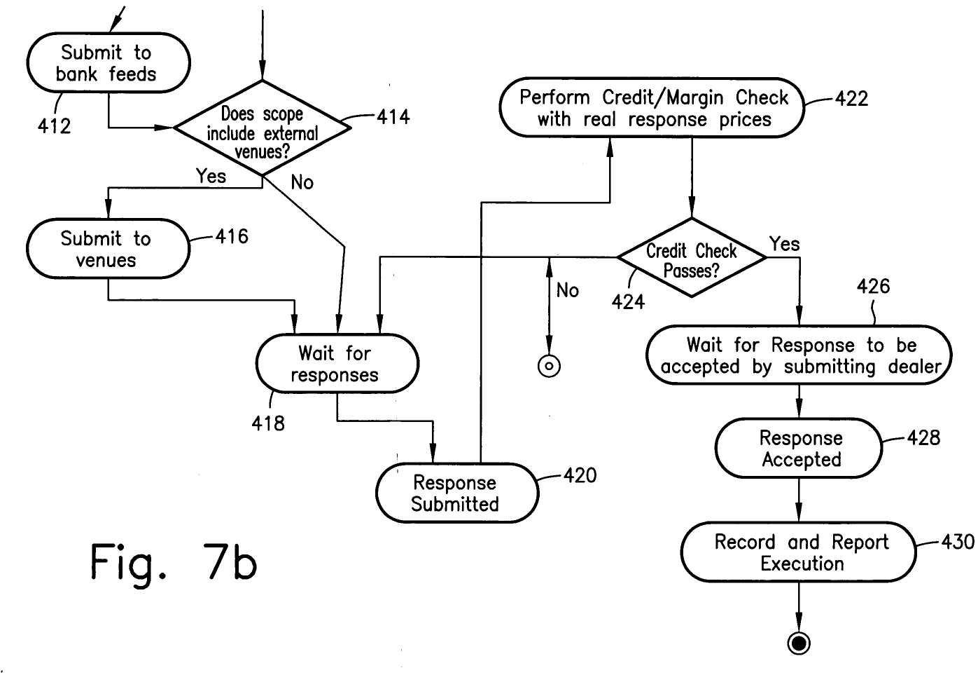

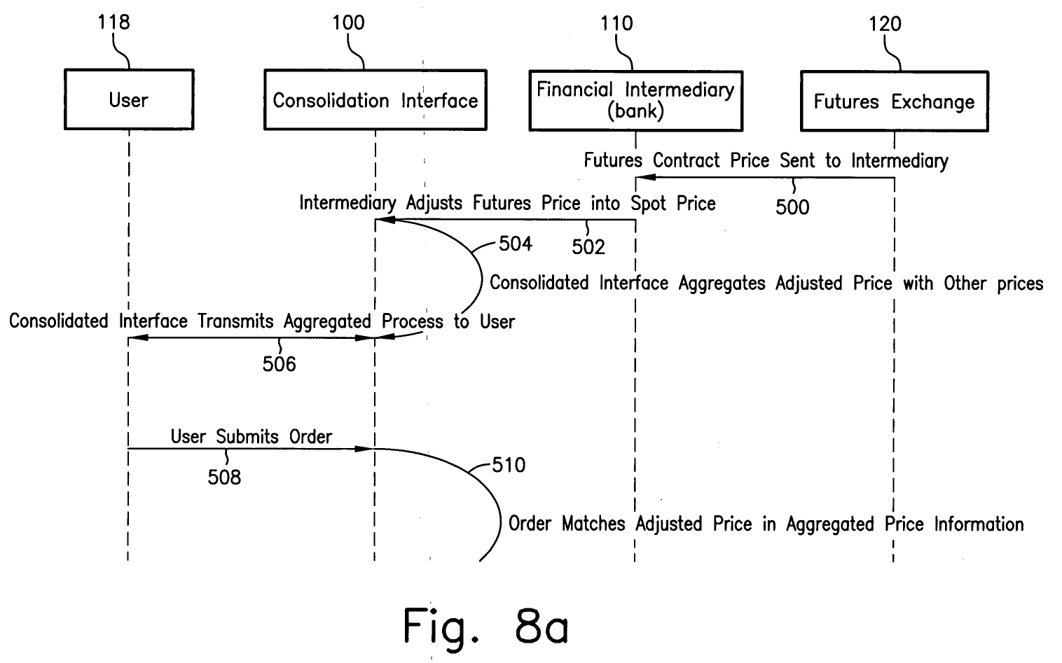

Referring once again to step 306, in the event that the consolidating interface 100 has compared the current Top Level Iterator to all of the available opposing prices, and there is not a better opposing price, the consolidating interface 100 can operate to formulate a Request For Quote (RFQ) on behalf of the party behind the Top Level Iterator, and proceed according to the flow chart of FIG. 7, as will be described below. In certain instances, the RFQ can comprise broadcast information regarding the unfilled order of the Top Level Iterator. The consolidating interface 100 can broadcast this information to various parties coupled to the foreign exchange trading platforms, such as to all liquidity providers. This will allow liquidity providers to decide whether to participate in the market by making a bid or offer to satisfy the outstanding order.

Referring now to FIG. 7, there is shown an illustrative flow chart for implementing a management routine for Requests For Quotes (RFQ) in a foreign exchange market, according to a feature of the present invention. As discussed above, traders may submit a request for a foreign exchange quote or other indication of interest (IOI) before actually placing an order. For example, in the case of a large order, one of an amount that will most likely effect market prices, a trader may want to obtain quote information before committing to an actual order. In addition, as discussed above, the consolidating interface 100 can generate an RFQ for a trader associated with a Top Level Iterator when there is no appropriate opposing price for the Top Level Iterator.

Pursuant to a feature of the present invention, the consolidating interface 100 utilizes the coupling it provides between customers 118, and the various electronic exchanges 102, multi-bank portals 104, and RFQ services to distribute Requests For Quotes to multiple providers of quote information. As shown in FIG. 7, the consolidating interface 100 begins Request for Quote processing upon submission via electronic transmission to the interface 100, of an RFQ by a broker/trader/customer 118 (submitting trader) (step 400). Also, as described above, the interface 100 itself can generate an RFQ on behalf of a trader. A submitting trader will indicate an instrument (currency pair, for example EUR/USD), and a quantity. The submitting trader can set the scope of distribution of the RFQ by specifying which type of parties the RFQ is to be distributed by the consolidating interface 100, for example, banks, dealers, brokers etc., and a duration for the RFQ. A party within each party type will only receive the RFQ if the specific party offers RFQ services. These parties can be banks 110 coupled to multi-bank portals 104, brokers 108 coupled to the electronic exchanges 102 and/or bank/dealers/brokers 114 coupled to the various RFQ services 106. Moreover, the RFQ's are only transmitted via electronic exchanges 102, multi-bank portals 104 and RFQ services 106 to which the submitting trader is a member or subscribes.

Pursuant to a feature of the present invention, in step 402, the consolidating interface 100 performs an initial credit check on the submitting trader (step 404). Since the RFQ does not include a price, Current Top Levels for the instrument specified by the submitting trader are retrieved by the consolidating interface 100 to serve as a basis for the credit check. The credit check can include performance of an exposure calculation, as described above. If the credit check fails, the consolidating interface 100 ends the RFQ processing.

In the event that the credit check passes, the consolidating interface 100 proceeds to distribute the RFQ as per the scope specified by the submitting trader. The RFQ can be distributed by the consolidating interface 100 to the various parties, in each case pursuant to a specific protocol or mechanism prescribed by the particular specified party. In each such case, the consolidating interface 100 operates to translate the RFQ according to each specific protocol or mechanism.

In step 406 the consolidating interface 100 ascertains whether the submitting trader has specified brokers/dealers. If yes, the consolidating interface 100 proceeds to step 408 and distributes the RFQ to brokers/dealers 108 coupled to the electronic exchanges 102 and/or broker/dealers 114 coupled to the various RFQ services 106. If no, the consolidating interface proceeds to step 410. Also, in the event the interface 100 has executed step 408, after completing step 408, the consolidating interface 100 proceeds to step 410.

In step 410, the consolidating interface 100 ascertains whether the submitting trader has specified banks. If yes, the consolidating interface 100 proceeds to step 412, and distributes the RFQ to each bank providing a price feed, offering RFQ services, and coupled to the interface 100 via, for example, the multi-bank portals 104. If no, the consolidating interface proceeds to step 414. Also, in the event the interface 100 has executed step 412, after completing step 412, the consolidating interface 100 proceeds to step 414.

In step 414, the consolidating interface 100 ascertains whether the submitting trader has specified any other venues that may be selected by a submitting trader. If yes, the consolidating interface 100 proceeds to step 416, and distributes the RFQ to each other specified party coupled to the interface 100. If no, the consolidating interface proceeds to step 418. Also, in the event the interface 100 has executed step 416, after completing step 416, the consolidating interface 100 proceeds to step 418.

In step 418, the consolidating interface 100 waits for responses to the RFQ's sent in the preceding steps. Such responses received by the consolidating interface 100 may be in a particular protocol or mechanism prescribed by the specific party. In each such case, the consolidating interface 100 will translate the response into a format compatible with the computer environment of the submitting trader.

In step 420, the consolidating interface 100 sends all translated RFQ responses to the submitting trader. This can be in the form of a real time screen display showing all of the responses simultaneously. The submitting trader can then select the response that offers the best price for the submitting trader. In addition, at this time, a credit check can be performed once again (step 422) on both the submitting trader, and the parties responding to the RFQ, with actual prices, as contained in the responses.

In step 424, the consolidating interface 100 determines wether the credit check passed. If no, the consolidating interface 100 exits the RFQ processing. If yes, the consolidating interface proceeds to step 426, to wait for the selection by the submitting trader. In steps 428 and 430, the foreign exchange indicated by the response to the RFQ selected by the submitting trader is subject to execution and a record and report routine. The execution can be as in the order matching scheme described above. Accordingly, the trade can be auto-executed between parties that are each a customer 118 coupled to the consolidating interface 100, or transmitted for execution to the foreign exchange trading platform wherein the response to the RFQ originated.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A computerized method for routing orders for foreign exchange transactions, comprising the steps of:
(a) receiving and aggregating updated foreign exchange price information from a plurality of foreign exchange electronic markets;
(b) receiving and aggregating updated foreign exchange price information from a plurality of multi-bank foreign exchange portals;
(c) merging and sorting the foreign exchange price information of steps (a) and (b), according to preselected criteria, to create a complete order book.

2. The computerized method of claim 1, comprising the further step of receiving and aggregating updated foreign exchange price information from a plurality of sell-side markets, and merging and sorting the foreign exchange information from the sell-side markets when creating the complete order book.

3. The computerized method of claim 1, comprising the further step of distributing the complete order book to users.

4. The computerized method of claim 3, comprising the further step of at each of the users, displaying the complete order book according to sorting criteria selected by the user.

5. The computerized method of claim 3, comprising the further steps of receiving a foreign exchange order from a user, and matching the received order with the foreign exchange price information of the complete order book to determine opposing orders for execution.

6. The computerized method of claim 5, wherein the foreign exchange order includes a quantity, and comprising the further step of forming an execution set from the received order and a determined set of opposing orders to satisfy the quantity of the foreign exchange order.

7. The computerized method of claim 6, wherein the execution set is processed as a single order for the user.

8. The computerized method of claim 3, wherein at least one of the users is permitted to receive updated foreign exchange price information only from certain preselected ones of the plurality of foreign exchange electronic markets and multi-bank foreign exchange portals, and comprising the further steps of filtering the complete order book to provide a user complete order book, including foreign exchange price information only from the certain preselected ones of the plurality of foreign exchange electronic markets and multi-bank foreign exchange portals, and distributing the user complete order book to the at least one of the users.

9. The computerized method of claim 3, comprising the further step of, prior to distributing the complete order book to users, adjusting the foreign exchange information for preselected ones of the users.

10. A computerized method for routing orders for foreign exchange transactions, comprising the steps of:
(a) receiving and aggregating updated foreign exchange price information from a plurality of foreign exchange trading platforms;
(b) receiving a foreign exchange order from a party;
(c) matching the order with the aggregated, updated foreign exchange price information to determine a pair of opposing orders for execution from among the plurality of foreign exchange trading platforms;
(d) in the event there is a match, executing the determined pair of opposing orders;
(e) in the event there is not a match, generating an RFQ representing the foreign exchange order, and transmitting the RFQ to the plurality of foreign exchange trading platforms.

11. The computerized method of claim 10, wherein the RFQ comprises broadcast information.

12. A computerized method for routing orders for foreign exchange transactions, comprising the steps of:
(a) receiving and aggregating updated foreign exchange price information from a plurality of foreign exchange trading platforms;
(b) receiving a foreign exchange order from a party;
(c) matching the order with the aggregated, updated foreign exchange price information to determine a pair of opposing orders for execution from among the plurality of foreign exchange trading platforms;
(d) performing an automatic routine for a pre-execution check to the determined pair of opposing orders for execution; and
(e) executing the determined pair of opposing orders only if the pre-execution check succeeds.

13. A computerized method for routing orders for foreign exchange transactions, comprising the steps of:
(a) receiving and aggregating updated foreign exchange price information from a plurality of foreign exchange trading platforms;
(b) coding the aggregated foreign exchange information to highlight best trade information from among the foreign exchange trading platforms; and
(c) transmitting the coded, aggregated foreign exchange information to a user.

14. The computerized method of claim 13, wherein the coding comprises color coding.

15. A computerized method for routing orders for foreign exchange transactions, comprising the steps of:
(a) utilizing an interface to couple a user to a plurality of foreign exchange trading platforms, each of the foreign exchange trading platforms having a coupling to a plurality of RFQ service providers, the RFQ service providers each being of one of a plurality of distinct types of RFQ service providers;
(b) receiving at the interface, an RFQ from the user, the RFQ specifying types of RFQ service providers;
(c) operating the interface to distribute the RFQ to the types of RFQ service providers specified in the RFQ;
(d) receiving at the interface, responses to the RFQ from the plurality of specified RFQ service providers; and
(e) transmitting the responses to the user.

16. A computerized method for routing orders for foreign exchange transactions, comprising the steps of:
(a) utilizing an interface to couple a user to a plurality of foreign exchange trading platforms, each of the foreign exchange trading platforms having a coupling to a plurality of RFQ service providers;
(b) receiving at the interface, an RFQ from the user;
(c) operating the interface to distribute the RFQ to the RFQ service providers;
(d) receiving at the interface, responses to the RFQ from the plurality of RFQ service providers;
(e) transmitting the responses to the user;
(f) receiving at the interface, a single response selected from among the responses by the user for execution as an order;
(g) performing automatic routines for a pre-execution check to the response selected by the user for execution as an order; and
(f) executing the order only if the pre-execution check succeeds.

17. A computerized method for routing orders for foreign exchange transactions, comprising the steps of:
(a) utilizing an interface to couple a user to a plurality of foreign exchange trading platforms, each of the foreign exchange trading platforms having a coupling to a plurality of RFQ service providers operating according to a preselected protocol;
(b) receiving at the interface, an RFQ from the user;
(c) operating the interface to translate and distribute the RFQ to the RFQ service providers, each according to the corresponding protocol;
(d) receiving at the interface, responses to the RFQ from the plurality of RFQ service providers; and
(e) translating and transmitting the responses to the user.

18. A computerized method for routing orders for foreign exchange transactions, comprising the steps of:
(a) receiving and aggregating updated foreign exchange price information from a plurality of foreign exchange trading platforms;
(b) receiving and aggregating updated foreign exchange price information comprising spot prices derived from futures prices quoted in a futures market by performing a risk adjustment to the futures prices;
(c) merging and sorting the foreign exchange price information of steps (a) and (b), according to preselected criteria, to create a complete order book.

19. The computerized method of claim 18 comprising the further steps of:
(a) distributing the complete order book to users;
(b) receiving a foreign exchange order from a user; and
(c) matching the received order with the foreign exchange price information of the complete order book to determine opposing orders for execution.
